(19) United States
(12) Patent Application Publication
(10) Pub. No.: US 2025/0347552 A1
(43) Pub. Date: Nov. 13, 2025

(54) Hit Detection Device and Musical Instrument

(71) Applicant: YAMAHA CORPORATION, Hamamatsu-shi (JP)

(72) Inventors: Yusuke SATO, Kanagawa (JP); Keizo HARADA, Hamamatsu-shi (JP); So TANAKA

(21) Appl. No.: 19/277,515

(22) Filed: Jul. 23, 2025

Related U.S. Application Data
(63) Continuation of application No. PCT/JP2024/003384, filed on Feb. 2, 2024.

(30) Foreign Application Priority Data
Feb. 3, 2023 (JP) 2023-015222

(51) Int. Cl. G01H 11/08; G10H 3/14

(52) U.S. Cl. CPC G01H 11/08; G10H 3/143; G10H 3/146; G10H 2220/525

(57) ABSTRACT

A hit detection device that detects vibrations in an object includes a vibration transmission member and two vibration detection sensors. The vibration transmission member includes a contact portion in contact with the object, and deforms in response to the vibrations in the object. The sensors each detect deformation in each of two different portions of the vibration transmission member. The two portions of the vibration transmission member are arranged in a direction intersecting an alignment direction in which the object and the vibration transmission member are aligned.

### CROSS-REFERENCE TO RELATED APPLICATIONS

The present application is a continuation application of International Application No. PCT/JP2024/003384, filed Feb. 2, 2024, which claims priority to Japanese Patent Application No. 2023-015222, filed Feb. 3, 2023. The contents of these applications are incorporated herein by reference in their entirety.

### BACKGROUND

The present disclosure relates to a hit detection device and a musical instrument.

JP 2015-138196 A1 discloses a hit detection device used for an electronic percussion instrument that emits an electronic sound based on an impact on a plate-like struck member (pad, or vibrator). The hit detection device according to JP 2015-138196 A1 uses a sensor to detect the vibrations of the struck member, and this sensor is provided on a side face that extends in the thickness direction of the struck member. The sensor can thus detect longitudinal vibration waves when the striking surface (upper surface) of the struck member, which is oriented perpendicular to the thickness direction, is subjected to an impact. The longitudinal waves of vibration propagate faster than the transverse waves. Therefore, detecting the longitudinal waves can shorten the time between the impact on the struck member and the emission of an electronic sound. The longitudinal vibration waves are parallel to the direction in which the wave travels (along the striking surface). The transverse vibration waves are perpendicular to the direction in which the wave travels (along the striking surface).

However, if the struck member (object) is in the form of a thin membrane such as a mesh or film, the hit detection device according to JP 2015-138196 A1 cannot be mounted on the object, that is, the device cannot detect the longitudinal vibration waves of the struck member.

The present disclosure was made in view of the circumstance described above. It is an object of the present disclosure to provide a hit detection device that allows for the detection of longitudinal vibration waves in an object (struck member) even when the object is a thin membrane.

### SUMMARY

One aspect is a hit detection device that detects vibrations in an object includes a vibration transmission member and two vibration detection sensors. The vibration transmission member includes a contact portion in contact with the object, and deforms in response to the vibrations in the object. Each of the two vibration detection sensors is configured to detect deformation in each of two different portions of the vibration transmission member. The two portions of the vibration transmission member are arranged in a direction intersecting an alignment direction in which the object and the vibration transmission member are aligned.

Another aspect is a musical instrument that has a hit detection device configured to detect vibrations in a striking surface. The musical instrument includes a vibration transmission member and two vibration detection sensors. The vibration transmission member includes a contact portion in contact with the striking surface and configured to deform in response to the vibrations. Each of the two vibration detection sensors is configured to detect deformation in each of two different portions of the vibration transmission member. The vibration detection sensors is arranged along the striking surface.

A more complete appreciation of the present disclosure and many of the attendant advantages thereof will be readily obtained as the same becomes better understood by reference to the following detailed description when considered in connection with the following figures, in which:

### BRIEF DESCRIPTION OF THE DRAWINGS

FIG. 1 is a cross-sectional side view illustrating a hit detection device according to a first embodiment of the present disclosure;

FIG. 2 is a cross-sectional view along the line II-II in FIG. 1;

FIG. 3 is a block diagram illustrating the hit detection device according to the first embodiment of the present disclosure;

FIG. 4 is a diagram illustrating a first example of operation of the hit detection device in FIG. 1;

FIG. 5 is a diagram illustrating a second example of operation of the hit detection device in FIG. 1;

FIG. 6 is a diagram illustrating an example of arrangement of the hit detection device of FIG. 1 and FIG. 2 relative to an object;

FIG. 7 is a cross-sectional side view illustrating a modification of the hit detection device according to the first embodiment of the present disclosure;

FIG. 8 is a cross-sectional plan view illustrating a hit detection device according to a second embodiment of the present disclosure;

FIG. 9 is a diagram illustrating an example of arrangement of the hit detection device of FIG. 8 relative to an object;

FIG. 10 is a graph showing the relationship between the direction of vibration propagation (angle θ) and the three, first to third, pressure differences (output values) when the hit detection device is arranged as shown in FIG. 9;

FIG. 11 is a diagram illustrating another example of arrangement of the hit detection device of FIG. 1 and FIG. 2 relative to an object;

FIG. 12 is a diagram illustrating another example of arrangement of the hit detection device of FIG. 1 and FIG. 2 relative to an object; and

FIG. 13 is a cross-sectional side view illustrating a hit detection device according to another embodiment of the present disclosure.

### DETAILED DESCRIPTION

The present specification is applicable to a hit detection device and a musical instrument.

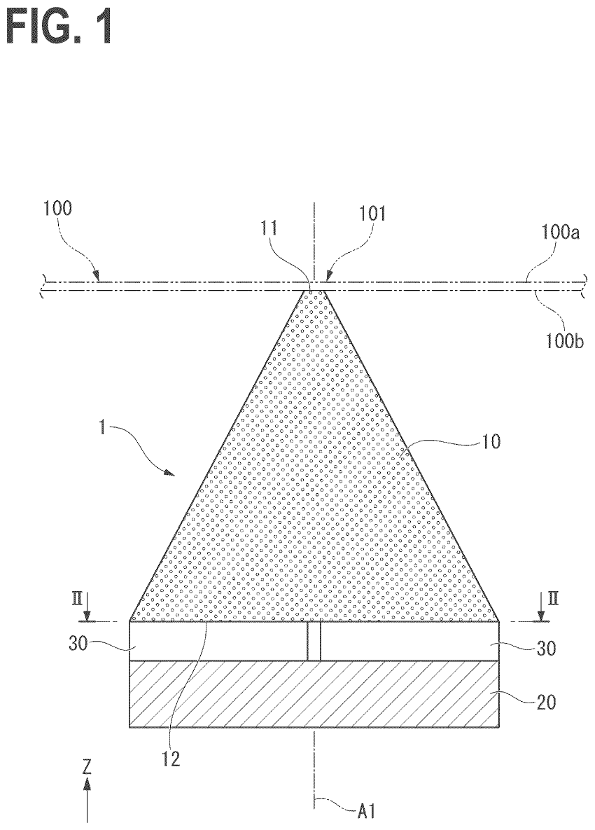

A first embodiment of the present disclosure is described with reference to FIG. 1 to FIG. 6.

The hit detection device 1 according to the first embodiment shown in FIG. 1 detects vibrations in an object 100. The object 100 in the first embodiment is a struck member in the form of a plate or membrane that vibrates when struck. The object 100 in the form of a plate or membrane has a striking surface 100a that is hit by a stick or the like. In the following description, the surface of the object 100 opposite to the striking surface 100a may be referred to as “the backside 100b.” The object 100 is supported on a base (not shown). The base may be, for example, a drum shell.

The hit detection device 1 includes a vibration transmission member 10, a support base 20, and two vibration detection sensors 30.

The vibration transmission member 10 has a contact portion 11 that is in contact with the object 100. The vibration transmission member 10 deforms in response to vibrations in the object 100. The vibration transmission member 10 undergoes elastic deformation such as that of a sponge, for example.

The support base 20 supports the vibration transmission member 10 to set the vibration transmission member 10 in position between itself and the object 100. Namely, the vibration transmission member 10 is sandwiched between the support base 20 and the object 100.

The two vibration detection sensors 30 detect deformation in two different portions of the vibration transmission member 10. The two portions of the vibration transmission member 10, that is, the detection targets of the two vibration detection sensors 30, are arranged in a direction intersecting the direction in which the vibration transmission member 10 and the support base 20 are aligned (hereinafter also referred to as the z-axis direction).

The hit detection device 1 according to the first embodiment is described in more specific terms below.

The vibration transmission member 10 of the first embodiment is in the form of a cone (truncated cone) with the contact portion 11 at the top and a portion 12 opposite the support base 20 (hereinafter referred to as the opposite portion 12) as the bottom. The vibration transmission member 10 may be formed in a pyramidal shape, such as a square or triangular pyramid. In the first embodiment, it is conical.

For example, the contact portion 11 (top) of the vibration transmission member 10 may be formed to conform to the shape of a portion of the object 100 where the contact portion 11 makes contact. More specifically, when the object 100 is flat at the portion where the contact portion 11 makes contact, the contact portion 11 (top) of the vibration transmission member 10 may be formed as a flat surface. That is, the vibration transmission member 10 may be formed in a truncated conical shape. Alternatively, for example, the vibration transmission member 10 itself may be formed in a conical shape, and transform into a truncated conical shape, when the contact portion 11 (top) is pressed against a flat surface of the object 100 and flattened by elastic deformation.

The vibration detection sensors 30 in the first embodiment are pressure sensors that detect pressure via elastic deformation. The pressure sensor is configured with electrodes provided at both ends in the thickness direction of an elastically deformable piezoelectric element, for example. The vibration detection sensors 30, or the pressure sensors, are in contact with the vibration transmission member 10. This allows the vibration detection sensors 30 to detect changes in the pressure applied to the vibration detection sensors 30 as the vibration transmission member 10 undergoes deformation.

More specifically, the vibration detection sensors 30 in the first embodiment are pressure sensors that detect pressure based on elastic compression (extension) in its thickness direction (in which the vibration transmission member 10 and the support base 20 are aligned). For example, polyvinylidene fluoride (PVDF) may be used for the piezoelectric element.

In the first embodiment, the two vibration detection sensors 30 are sandwiched between the vibration transmission member 10 and the support base 20. Namely, the support base 20 supports the vibration transmission member 10 via the two vibration detection sensors 30. The vibration detection sensors 30 facing the opposite portion 12 of the vibration transmission member 10 are in full surface contact with the opposite portion 12. The two vibration detection sensors 30 are in contact with two different areas of the opposite portion 12. While the two vibration detection sensors 30 in FIG. 1 are arranged perpendicularly to the direction in which the vibration transmission member 10 and the support base 20 are aligned (z-axis direction), the sensors may be arranged in any direction that at least intersects this alignment direction.

As mentioned above, the vibration detection sensors 30 are pressure sensors that undergo elastic compression (extension) in their thickness direction. Therefore, the support base 20 holds the vibration detection sensors 30 entirely between itself and the vibration transmission member 10. The support base 20 has a higher modulus of elasticity than the vibration detection sensors 30.

In the first embodiment, the two vibration detection sensors 30, or the pressure sensors, are each configured as a piezoelectric element with electrodes at both ends. Instead, for example, the two vibration detection sensors 30 may be formed by a single piezoelectric element with two separate sets of electrodes at both ends.

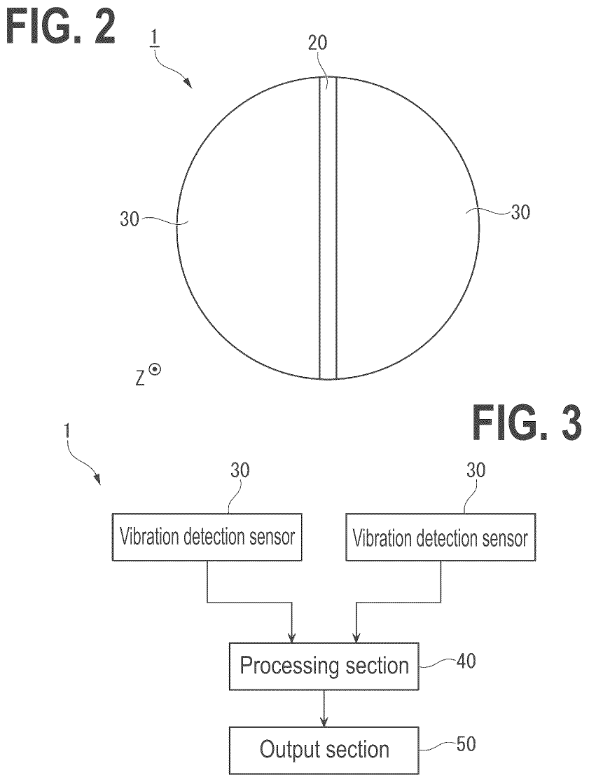

As mentioned above, the vibration transmission member 10 in the first embodiment is conical. Therefore, as shown in FIG. 2, the support base 20 is circular when viewed in the z-axis direction, corresponding to the opposite portion 12 (bottom) of the vibration transmission member 10. Each of the two vibration detection sensors 30 is semicircular when viewed in the z-axis direction. The two semicircular vibration detection sensors 30 are arranged to form a circle as a whole corresponding to the opposite portion 12 (bottom) of the vibration transmission member 10.

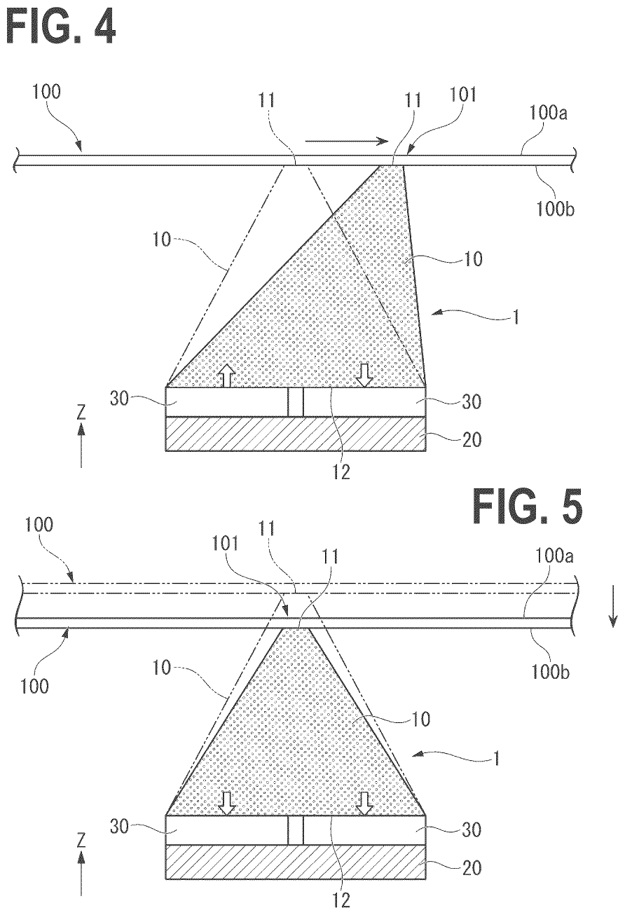

The operation of the hit detection device 1 thus configured is described with reference to FIG. 4 and FIG. 5.

As shown in FIG. 4 and FIG. 5, the hit detection device 1 is mounted on the object 100 such that the contact portion 11 of the vibration transmission member 10 is in contact with the backside 100b of the object 100, and that the vibration transmission member 10 is sandwiched between the object 100 and the support base 20. The support base 20 may be fixed to a base (not shown) that supports the object 100, for example. The contact portion 11 may be in contact with the striking surface 100a of the object 100, for example.

With the hit detection device 1 mounted on the object 100 in this way, the two vibration detection sensors 30 are arranged along the direction in which the striking surface 100a (backside 100b) of the object 100 extends. Namely, the two different portions of the vibration transmission member 10, whose deformation is detected by the two vibration detection sensors 30, are arranged along the striking surface 100a of the object 100. While the two vibration detection sensors 30 in FIG. 4 and FIG. 5 are oriented parallel to the striking surface 100a of the object 100, they may be inclined to the striking surface 100a, for example. The two vibration detection sensors 30 may be arranged in any direction as long as they are not oriented perpendicularly to the striking surface 100a of the object 100.

In the state shown in FIG. 4 and FIG. 5, when the object 100 is struck on its striking surface 100a, it vibrates, and the resulting vibration propagates along the striking surface 100a of the object 100. The vibration of the object 100 passing through the contact portion 11 of the vibration transmission member 10 causes the contact portion 11 to displace relative to the opposite portion 12 of the vibration transmission member 10 on the side closer to the support base 20.

As the vibration of the object 100 passes through the contact portion 11 of the vibration transmission member 10 in the direction in which the two vibration detection sensors 30 are arranged along the striking surface 100a, the longitudinal vibration waves of the object 100 cause the contact portion 11 of the vibration transmission member 10 to displace in the direction in which the two vibration detection sensors 30 are arranged (left-right direction in FIG. 4 and FIG. 5) relative to the opposite portion 12 as shown in FIG. 4, for example. The deformation of the vibration transmission member 10 caused by this displacement of the contact portion 11 causes pressures of opposite signs to be applied to the two vibration detection sensors 30. In FIG. 4, the two arrows touching the vibration detection sensors 30 indicate the directions of pressure acting on each vibration detection sensor 30. In the example shown in FIG. 4, the vibration detection sensor 30 on the right side is compressed in its thickness direction, while the vibration detection sensor 30 on the left side is extended in its thickness direction. Therefore, the hit detection device 1 can detect the longitudinal vibration wave from the difference between the pressures (pressure values) detected and output by these two vibration detection sensors 30.

When the object 100 is hit and the resulting vibration passes through the contact portion 11 of the vibration transmission member 10, as shown in FIG. 5, the transverse vibration waves of the object 100 cause the contact portion 11 of the vibration transmission member 10 to displace in the direction in which the vibration transmission member 10 and the support base 20 are aligned (i.e., direction intersecting the direction in which the two vibration detection sensors 30 are arranged) relative to the opposite portion 12. The deformation of the vibration transmission member 10 caused by this displacement of the contact portion 11 causes pressures of the same sign to be applied to the two vibration detection sensors 30. In FIG. 5, the two arrows touching the vibration detection sensors 30 indicate the directions of pressure acting on each vibration detection sensor 30. In the example shown in FIG. 5, the two vibration detection sensors 30 are both compressed in their thickness direction. Therefore, the hit detection device 1 can detect the transverse vibration wave from the sum (addition) of the pressures (pressure values) detected and output by these two vibration detection sensors 30.

For the detection of longitudinal and transverse vibration waves, the two vibration detection sensors 30 may be deformed (pressed) beforehand in a certain direction, for example, and the pressure on the sensors may be detected with reference to this deformed state.

As shown in FIG. 3, the hit detection device 1 of the first embodiment further includes a processing section 40 and an output section 50. The processing section 40 processes the output values from the two vibration detection sensors 30. The output section 50 causes an electronic sound to be emitted from a speaker or the like (not shown) based on the processing result output by the processing section 40. Namely, the hit detection device 1 is configured to be adaptable to an electronic percussion instrument that produces an electronic sound.

As described above, the vibration detection sensors 30 in the first embodiment detect the pressure applied thereto. Therefore, the “output values” from the two vibration detection sensors 30 that are processed by the processing section 40 indicate pressure. In the following description, the term “pressure value” is used as an equivalent to “output value.”

The processing section 40 includes a processor and a determination section. The processor calculates the difference between the pressure values output by the two vibration detection sensors 30. Subtracting the pressure values corresponds to the detection of a longitudinal vibration wave of the object 100. The processor also calculates the sum of the pressure values output by the two vibration detection sensors 30. Summing the pressure values corresponds to the detection of a transverse vibration wave of the object 100. The processor also calculates the difference between the time of a peak in the difference between the pressure values and the time of a peak in the sum of the pressure values.

A peak in the difference between pressure values here corresponds to a peak in a longitudinal vibration wave of the object 100 when it is struck. A peak in the sum of pressure values corresponds to a peak in a transverse vibration wave of the object 100 when it is struck. Namely, the processor calculating the difference between the time of a peak in the difference between the pressure values and the time of a peak in the sum of the pressure values equals to calculating a time difference between a longitudinal wave and a transverse wave of vibration that have reached the contact portion 11 in contact with the object 100.

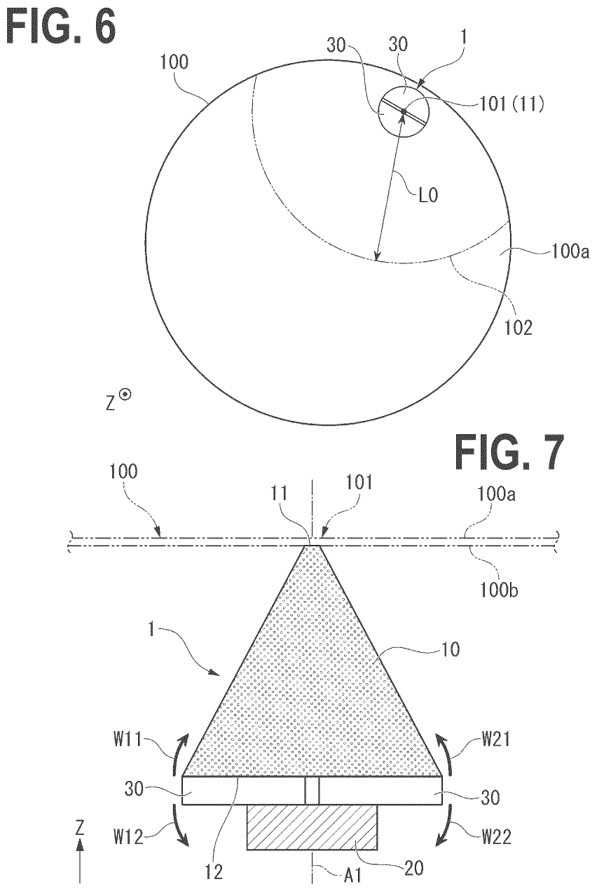

The determination section determines the distance L0 from the contact point 101 where the contact portion 11 (see FIG. 1) of the vibration transmission member 10 is in contact with the object 100 to a hit point where the object 100 was struck, as shown in FIG. 6, based on the “time difference” output by the processor and the propagation speed of the vibration (longitudinal wave and transverse wave) of the object 100. In FIG. 6, the two-dot chain line denoted at 102 represents a circular arc region spaced at the distance L0 from the contact point 101 of the object 100. The hit point of the object 100 is within this circular arc region 102.

The determination section may also determine the intensity (magnitude) of the hit on the object 100 based on the difference and/or the peak in the difference between pressure values calculated by the processor.

The output section 50 shown in FIG. 3 allows electronic sounds of different timbres to be emitted according to the distance L0 output by the determination section. For example, the hit point may be determined from the distance L0 output by the determination section, and electronic sounds of different timbres may be emitted according to the location of the hit point. The electronic sound is emitted with a velocity (volume) corresponding to the intensity (magnitude) of the hit on the object 100 determined by the determination section.

For example, the processor in the processing section 40 may calculate only the difference between pressure values output by the two vibration detection sensors 30, that is, may detect only the longitudinal vibration wave of the object 100. The processor may calculate the peak in the difference between the pressure values. The determination section in the processing section 40 may determine the intensity (magnitude) of the hit on the object 100 based on the peak in the difference between the pressure values calculated by the processor. The output section 50 may cause an electronic sound to be emitted with a velocity (volume) corresponding to the intensity (magnitude) of the hit on the object 100 determined by the determination section according to the timing when the difference between the pressure values (longitudinal vibration wave) is output by the processing section 40.

The longitudinal waves of vibration propagate faster than the transverse waves. Therefore, by using only the longitudinal vibration waves as described above, the time from when the object 100 is struck until an electronic sound is emitted can be shortened compared to when using both the longitudinal and transverse waves of vibration.

The hit detection device 1 of the first embodiment should preferably be mounted on the object 100 in a peripheral area spaced from the central region of the object 100 when viewed in the z-axis direction (thickness direction of the object 100) as shown in FIG. 6, for example. The object 100 is mostly hit in its central region. Therefore, by mounting the hit detection device 1 in a peripheral area of the object 100, the contact point 101 of the object 100 and its vicinity can be prevented from being hit. Preventing the contact point 101 of the object 100 and its vicinity from being hit ensures favorable detection of the difference in the time at which the longitudinal and transverse vibration waves reach the contact point 101.

The hit detection device 1 should preferably be mounted on the object 100 such that the two vibration detection sensors 30 are arranged in the direction from the central region to a peripheral area (radial direction in FIG. 6). By mounting the hit detection device 1 on the object 100 in this way, most of the object 100 (striking surface 100a) is located on one side in the direction in which the two vibration detection sensors 30 are arranged. This facilitates the determination of the hit point on the object 100.

As described above, the hit detection device 1 of the first embodiment includes two vibration detection sensors 30 for detecting deformation in two different portions of the vibration transmission member 10, and these two portions are arranged along a direction intersecting the direction in which the vibration transmission member 10 and the support base 20 are aligned (z-axis direction). This allows for the detection of longitudinal vibration waves of the object 100 even when the object 100 (struck object) is a thin membrane.

In the hit detection device 1 of the first embodiment, the vibration transmission member 10 is in the form of a cone with the contact portion 11 at the top and the opposite portion 12 opposite the support base 20 as the bottom. Therefore, the contact area between the contact portion 11 and the object 100 (striking surface 100a) can be made small. This prevents or minimizes changes in the vibration characteristics of the object 100 caused by contact with the vibration transmission member 10.

In the hit detection device 1 of the first embodiment, the vibration detection sensors 30 are sandwiched between the vibration transmission member 10 and the support base 20. More specifically, the vibration detection sensors 30 that undergo elastic compression (extension) in their thickness direction are entirely sandwiched between the vibration transmission member 10 and the support base 20. The support base 20 has a higher modulus of elasticity than the vibration detection sensors 30. The vibration detection sensors 30 can thereby be actively compressed (extended) in response to the vibrations (pressure fluctuations) transmitted from the object 100 to the vibration transmission member 10. This enables each vibration detection sensor 30 to detect vibrations in the object 100 with high sensitivity.

In the hit detection device 1 of the first embodiment, the vibration detection sensors 30 are pressure sensors that detect pressure via elastic deformation, and are in contact with the vibration transmission member 10. The vibration detection sensors 30 can therefore easily follow the deformation of the vibration transmission member 10 and detect the vibrations in the object 100 with high sensitivity.

In the hit detection device 1 of the first embodiment, the processor calculates the difference between the output values (pressure values) of the two vibration detection sensors 30, thereby allowing the detection of a longitudinal vibration wave of the object 100. By detecting the longitudinal vibration wave, the time from when the object 100 is hit until an electronic sound is emitted can be shortened.

In the hit detection device 1 of the first embodiment, the processor calculates the difference between the time of a peak in the difference between pressure values and the time of a peak in the sum of pressure values. This allows for the determination of the distance L0 from the contact point 101 of the object 100 to a hit point at least in the direction in which the two vibration detection sensors 30 are arranged. By determining the distance L0, the timbre of the electronic sound emitted from the electronic percussion instrument can be changed according to the distance L0. In other words, the timbre of the electronic sound emitted from the electronic percussion instrument can be varied according to the location of the hit point of the object 100.

In the first embodiment, the vibration detection sensor 30 may be a pressure sensor that detects pressure via elastic bending deformation or warping in its thickness direction, for example. Examples of this type of pressure sensor include, but are not limited to, unimorph pressure sensors with a piezoelectric layer on one side of a bendable substrate, or bimorph pressure sensors with piezoelectric layers on both sides of a substrate.

In the case where the vibration detection sensors 30 detect pressure via bending deformation, the support base 20 may hold a part (e.g., a half) of each vibration detection sensor 30 between itself and the vibration transmission member 10 as shown in FIG. 7. The support base 20 may have a stiffness that does not inhibit the bending deformation in the vibration detection sensors 30. Such a structure allows each vibration detection sensor 30 to bend actively with the deformation of the vibration transmission member 10 in response to the vibrations transmitted from the object 100.

The support base 20 may have a stiffness that allows it, for example, to deform or follow the bending deformation in the vibration detection sensors 30.

In the configuration shown in FIG. 7, for example, when the vibration of the object 100 passes through the contact portion 11 of the vibration transmission member 10 in the direction in which the two vibration detection sensors 30 are arranged (left-right direction), the longitudinal vibration waves of the object 100 cause the contact portion 11 of the vibration transmission member 10 to displace in the left-right direction. This displacement of the contact portion 11 causes pressures of opposite signs to be applied to the two vibration detection sensors 30, bending the sensors in opposite directions. For example, when the vibration detection sensor 30 on the left side bends upwards as indicated by the arrow W11, the vibration detection sensor 30 on the right side bends downwards as indicated by the arrow W22. When the vibration detection sensor 30 on the left side bends downwards as indicated by the arrow W12, the vibration detection sensor 30 on the right side bends upwards as indicated by the arrow W21.

When the vibration of the object 100 passes through the contact portion 11 of the vibration transmission member 10 in the direction in which the two vibration detection sensors 30 are arranged, the transverse vibration waves of the object cause the contact portion 11 to displace in the up and down direction (in the direction in which the vibration transmission member 10 and the support base 20 are aligned). This displacement of the contact portion 11 causes pressures of the same sign to be applied to the two vibration detection sensors 30, bending the sensors in the same direction. For example, when the vibration detection sensor 30 on the left side bends upwards as indicated by the arrow W11, the vibration detection sensor 30 on the right side also bends upwards as indicated by the arrow W21. When the vibration detection sensor 30 on the left side bends downwards as indicated by the arrow W12, the vibration detection sensor 30 on the right side also bends downwards as indicated by the arrow W22.

In the configuration shown in FIG. 7, the elastically bendable vibration detection sensors 30 are partly sandwiched between the vibration transmission member 10 and the support base 20. The support base 20 has a stiffness that does not inhibit the bending deformation of the vibration detection sensors 30. This can actively compress (extend) the vibration detection sensors 30 in response to the vibrations (pressure fluctuations) transmitted from the object 100 to the vibration transmission member 10. Namely, the vibration detection sensors 30 can detect vibrations in the object 100 with high sensitivity.

In the configuration shown in FIG. 7, the support base 20 has a stiffness that allows it to deform or follow the bending deformation of the vibration detection sensors 30. This can effectively prevent the vibration detection sensors 30 from being damaged caused by the support base 20 when the vibration detection sensors 30 bend. Namely, the vibration detection sensors 30 can be protected.

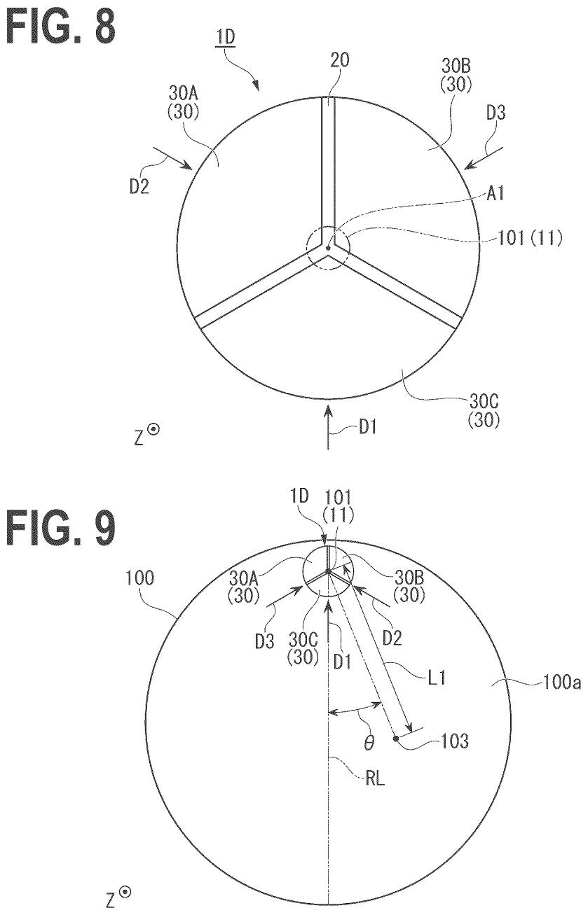

Next, a second embodiment of the present disclosure is described with reference to FIG. 8 to FIG. 10. In the following, the same or similar elements that have already been described are given the same reference numerals to avoid repetitive descriptions.

As shown in FIG. 8, the hit detection device 1D according to the second embodiment includes three vibration detection sensors 30. The three vibration detection sensors 30 respectively detect deformation in three portions of the vibration transmission member 10 circumferentially arranged about an axial line A1 extending in the z-axis direction (direction in which the vibration transmission member 10 and the support base 20 are aligned).

More specifically, in the hit detection device 1D of the second embodiment, similarly to the first embodiment, the three vibration detection sensors 30 are sandwiched between the vibration transmission member 10 and the support base 20. These three vibration detection sensors 30 are arranged circumferentially about an axial line A1 extending in the z-axis direction. The axial line A1 may for example coincide with the axial line of the vibration transmission member 10 (see FIG. 1).

Each of the vibration detection sensors 30 is fan-shaped when viewed in the z-axis direction so that the circumferential distance between adjacent vibration detection sensors 30 reduces. Each vibration detection sensor 30 has an open angle of 120 degrees in the circumferential direction.

In the following description, the three vibration detection sensors 30 may be referred to as a first vibration detection sensor 30A, a second vibration detection sensor 30B, and a third vibration detection sensor 30C.

The hit detection device 1D of the second embodiment, when mounted on the object 100 similarly to the first embodiment, can determine the direction in which vibrations pass (direction of vibration propagation) through the contact point 101 of the object 100 where the contact portion 11 of the vibration transmission member 10 is in contact. This feature is described below.

In the hit detection device 1D of the second embodiment, the processor calculates the difference (first pressure difference) between a sum of pressure values output by the first and second vibration detection sensors 30A and 30B and a pressure value output by the third vibration detection sensor 30C. This allows the detection of a longitudinal vibration wave propagating in the direction D1 (and in the opposite direction) in FIG. 8 with the highest sensitivity. The magnitude of the first pressure difference decreases as the direction in which the vibration propagates towards the contact point 101 (direction of vibration propagation) shifts circumferentially about the contact point 101 relative to the direction D1 (and the opposite direction), and becomes the smallest at ±90 degrees circumferentially from the direction D1 (and the opposite direction).

The processor also calculates the difference (second pressure difference) between a sum of pressure values output by the second and third vibration detection sensors 30B and 30C and a pressure value output by the first vibration detection sensor 30A. This allows the detection of a longitudinal vibration wave propagating in the direction D2 (and in the opposite direction) in FIG. 8 with the highest sensitivity. The magnitude of the second pressure difference decreases as the direction in which the vibration propagates towards the contact point 101 (direction of vibration propagation) shifts circumferentially about the contact point 101 relative to the direction D2 (and the opposite direction), and becomes the smallest at ±90 degrees circumferentially from the direction D2 (and the opposite direction).

The processor also calculates the difference (third pressure difference) between a sum of pressure values output by the first and third vibration detection sensors 30A and 30C and a pressure value output by the second vibration detection sensor 30B. This allows for the detection of a longitudinal vibration wave propagating in the direction D3 (and in the opposite direction) in FIG. 8 with the highest sensitivity. The magnitude of the third pressure difference decreases as the direction in which the vibration propagates towards the contact point 101 (direction of vibration propagation) shifts circumferentially about the contact point 101 relative to the direction D3 (and the opposite direction), and becomes the smallest at ±90 degrees circumferentially from the direction D3 (and the opposite direction).

In the hit detection device 1D of the second embodiment, similarly to the first embodiment, the processor calculates the sum (total sum) of pressure values output by the first to third vibration detection sensors 30. This allows for the detection of transverse vibration waves passing through the contact point 101 of the object 100.

The hit detection device 1D of the second embodiment is able to determine the distance and direction from the contact point 101 of the object 100 to a hit point where the object 100 was struck. This feature is described below.

A peak occurs in the first to third pressure differences mentioned above at the same time, that is, indicating the same time when a longitudinal vibration wave reaches the contact point 101 of the object 100. The processor calculates the difference between the time at which the peak occurred in the first to third pressure differences (the time it took for the longitudinal wave to reach), and the time at which a peak occurred in the total sum of the pressure values (the time it took for a transverse wave to reach). The determination section determines the distance L1 from the contact point 101 of the object 100 to the hit point, as shown in FIG. 9, based on the “time difference” output by the processor and the propagation speed of the vibration (longitudinal and transverse waves) of the object 100.

The ratio of the three, first to third, values (pressure differences) calculated and output by the processor varies according to a predetermined law as a function of the direction of propagation (angle θ) of the vibration towards the contact point 101 of the object 100. Using this law, the determination section determines the angle θ from a reference line RL based on the ratio of the three, first to third, values (pressure differences) output by the processor.

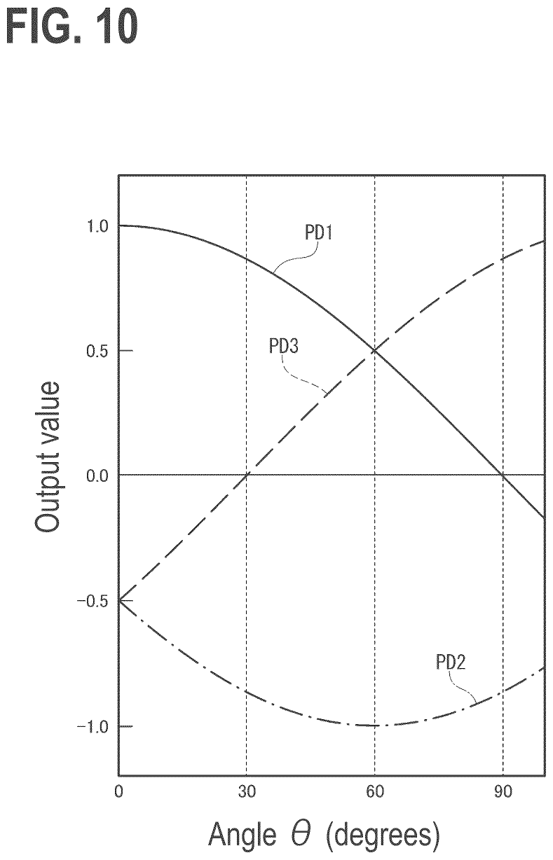

For example, the ratio of the three, first to third, values (pressure differences) output by the processor varies according to the angle θ as shown in FIG. 10. In FIG. 10, the reference numerals PD1, PD2, and PD3 denote the first to third pressure differences, respectively. The angle θ can thus be determined based on the ratio of these three output values PD1, PD2, and PD3.

This allows the direction of vibration propagation, that is, the direction of the hit point relative to the contact point 101, to be determined. The reference line RL extending from the contact point 101 in FIG. 9 coincides with the direction D1, but the direction of the reference line is not limited to this example.

The distance and direction from the contact point 101 of the object 100 to the hit point can thus be determined. Namely, the hit point 103 can be determined.

As shown in FIG. 9, the hit detection device 1D of the second embodiment should preferably be mounted on the object 100 in a peripheral area spaced from the central region of the object 100 when viewed in the z-axis direction (thickness direction of the object 100), similarly to the first embodiment.

The hit detection device 1D of the second embodiment provides the same or similar effects as the first embodiment.

In the hit detection device 1D of the second embodiment, the three vibration detection sensors 30 respectively detect deformation in three portions of the vibration transmission member 10 circumferentially arranged about the axial line A1 extending in the z-axis direction (direction in which the vibration transmission member 10 and the support base 20 are aligned). This allows for the detection of the longitudinal vibration waves propagating from different directions and passing through the contact point 101 of the object 100.

As described above, the hit detection device 1D of the second embodiment is able to determine the hit point 103 of the object 100. This allows electronic sounds of different timbres to be emitted from the output section 50 according to the hit point (impact area) on the object 100.

In the second embodiment, for example, there may be four or more vibration detection sensors 30 arranged in the circumferential direction. The more circumferentially arranged vibration detection sensors 30 there are, the more accurate is the determination of the propagation direction of the vibrations passing through the contact point 101 of the object 100. However, an excessive number of vibration detection sensors 30 will increase the operating load on the processor and may prolong the time between an impact on the object 100 and the emission of an electronic sound. It is therefore preferable not to increase the number of vibration detection sensors 30 more than necessary.

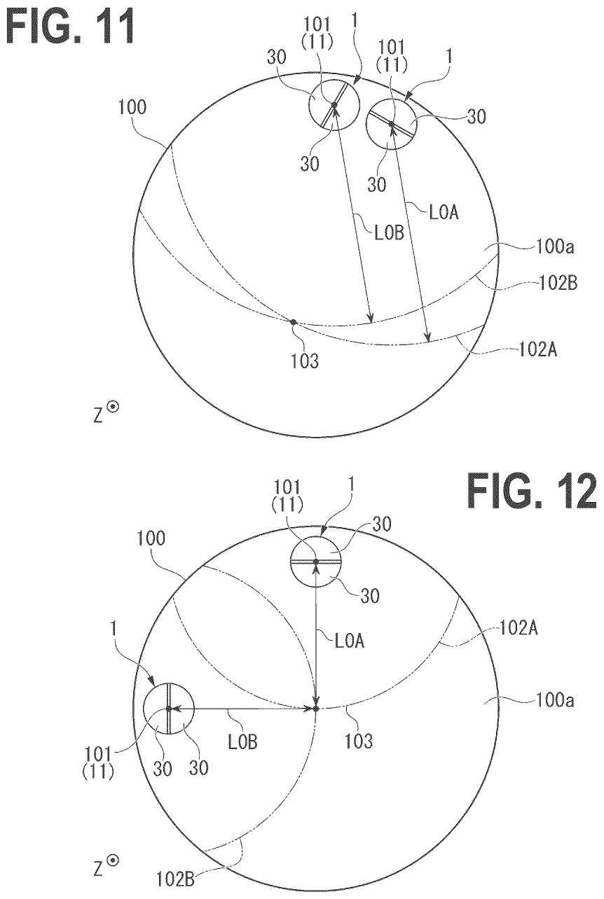

The hit point on the object 100 as described in the second embodiment can be determined not only by the hit detection device 1D of the second embodiment but also by the hit detection device 1 of the first embodiment having, for example, two vibration detection sensors 30. In this case, two hit detection devices 1 of the first embodiment are mounted on the object 100 as shown in FIG. 11 and FIG. 12. In FIG. 11 and FIG. 12, the two hit detection devices 1 are both mounted in a peripheral area of the object 100. The two hit detection devices 1 are arranged along the circumferential direction of the object 100. The direction in which the two vibration detection sensors 30 are aligned in one hit detection device 1 is perpendicular to the direction in which the two vibration detection sensors 30 are aligned in the other hit detection device 1.

In the case in which the two circumferentially arranged hit detection devices 1 are close to each other as shown in FIG. 11, the two vibration detection sensors 30 of only one of the hit detection devices 1 may be aligned in the direction from the central region to the peripheral area (radial direction in FIG. 11).

On the other hand, in the case in which the two circumferentially arranged hit detection devices 1 are spaced apart at 90 degrees as shown in FIG. 12, the two vibration detection sensors 30 of both of the hit detection devices 1 may be aligned in the direction from the central region to the peripheral area (radial direction in FIG. 12).

By using the two hit detection devices 1 positioned as shown in FIG. 11 and FIG. 12, the distance and direction from the contact point 101 of the object 100 to a hit point can be determined, that is, the hit point 103 can be determined by a method similar to the second embodiment.

In the case where two hit detection devices 1 positioned as shown in FIG. 11 and FIG. 12 are used, the hit point 103 can also be determined by the method shown in the first embodiment. Namely, as in the first embodiment, the determination section determines the distances LOA and LOB from the contact points 101 of the object 100, where the respective hit detection devices 1 are in contact, to the circular arc regions 102A and 102B containing the hit point. The determination section then determines the intersecting point of these two circular arc regions 102A and 102B as the hit point 103.

While the present disclosure has been described in detail, the present disclosure is not limited to the above embodiments. Various changes can be made without departing from the scope of the subject matter of the present disclosure.

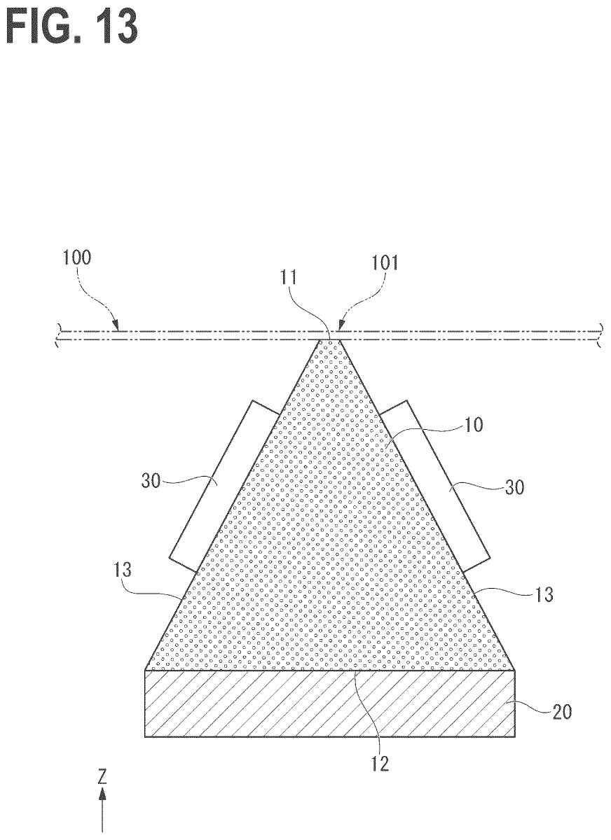

In the present disclosure, in the case where the vibration detection sensors 30 make contact with the vibration transmission member 10, the sensors may be in contact with a surface of the vibration transmission member 10 at least excluding the contact portion 11. The two vibration detection sensors 30 may be arranged in a direction intersecting the direction in which the vibration transmission member 10 and the support base 20 are aligned. For example, the vibration detection sensors 30 may be in contact with a portion of the vibration transmission member 10 where they are not sandwiched between the vibration transmission member 10 and the support base 20. For example, as shown in FIG. 13, the vibration detection sensors 30 may be in contact with a side face 13 of the vibration transmission member 10 that is formed in a conical shape. For example, the vibration detection sensors 30 may not be supported by the support base 20.

In the present disclosure, the vibration detection sensors 30 may not be in contact with the vibration transmission member 10 as long as the sensors can detect deformation in at least a plurality of different portions of the vibration transmission member 10. For example, the vibration detection sensors 30 may be of a type that detects deformation in the vibration transmission member 10 in a non-contact manner.

In the present disclosure, the object 100 may be a musical instrument, for example. The object 100 may be an acoustic or electronic musical instrument, for example. Examples of the acoustic musical instrument include, but are not limited to, percussion instruments such as bass drums, snare drums, tom-toms, and cymbals. The electronic musical instrument may be an electronic percussion instrument that emits a pre-recorded sound (sample sound) in response to the detection of a hit, including, but not limited to, an electronic drum and an electronic drum pad. The object 100 may be a resin pad, a rubber pad, or a mesh pad.

While embodiments of the present disclosure have been described, the embodiments are intended as illustrative only and are not intended to limit the scope of the present disclosure. It will be understood that the present disclosure can be embodied in other forms without departing from the scope of the present disclosure, and that other omissions, substitutions, additions, and/or alterations can be made to the embodiments. Thus, these embodiments and modifications thereof are intended to be encompassed by the scope of the present disclosure. The scope of the present disclosure accordingly is to be defined as set forth in the appended claims.

What is claimed is:

1. A hit detection device configured to detect vibrations in an object, the hit detection device comprising:
a vibration transmission member including a contact portion in contact with the object and configured to deform in response to the vibrations in the object; and
two vibration detection sensors each configured to detect deformation in each of two different portions of the vibration transmission member,
the two portions of the vibration transmission member being arranged in a direction intersecting an alignment direction in which the object and the vibration transmission member are aligned.

2. The hit detection device according to claim 1, wherein the device includes three or more vibration detection sensors,
the three or more vibration detection sensors each being configured to detect deformation in each of three or more portions of the vibration transmission member arranged circumferentially about an axis that extends in the alignment direction.

3. The hit detection device according to claim 1, further comprising a support base configured to position the vibration transmission member between itself and the object.

4. The hit detection device according to claim 3, wherein the vibration transmission member has the contact portion as an apex, and a portion opposite the support base as a bottom, of a conical shape.

5. The hit detection device according to claim 3, wherein the vibration detection sensors are sandwiched between the vibration transmission member and the support base.

6. The hit detection device according to claim 1, wherein each of the vibration detection sensors is a pressure sensor configured to detect pressure via elastic deformation and in contact with the vibration transmission member.

7. The hit detection device according to claim 1, further comprising a processor configured to calculate a difference between output values from the two vibration detection sensors.

8. The hit detection device according to claim 7, wherein the processor is configured to calculate:
the difference between the output values, and a sum of output values from the two vibration detection sensors; and
a difference between a time at which a peak occurred in the difference between the output values and a time at which a peak occurred in the sum of the output values.

9. A musical instrument having a hit detection device configured to detect vibrations in a striking surface, the musical instrument comprising:
a vibration transmission member including a contact portion in contact with the striking surface and configured to deform in response to the vibrations; and
two vibration detection sensors each configured to detect deformation in each of two different portions of the vibration transmission member,
the vibration detection sensors being arranged along the striking surface.

10. The hit detection device according to claim 2, further comprising a support base configured to position the vibration transmission member between itself and the object.

11. The hit detection device according to claim 10, wherein the vibration transmission member has the contact portion as an apex, and a portion opposite the support base as a bottom, of a conical shape.

12. The hit detection device according to claim 4, wherein the vibration detection sensors are sandwiched between the vibration transmission member and the support base.

13. The hit detection device according to claim 10, wherein the vibration detection sensors are sandwiched between the vibration transmission member and the support base.

14. The hit detection device according to claim 11, wherein the vibration detection sensors are sandwiched between the vibration transmission member and the support base.

15. The hit detection device according to claim 2, wherein each of the vibration detection sensors is a pressure sensor configured to detect pressure via elastic deformation and in contact with the vibration transmission member.

16. The hit detection device according to claim 3, wherein each of the vibration detection sensors is a pressure sensor configured to detect pressure via elastic deformation and in contact with the vibration transmission member.

17. The hit detection device according to claim 4, wherein each of the vibration detection sensors is a pressure sensor configured to detect pressure via elastic deformation and in contact with the vibration transmission member.

18. The hit detection device according to claim 5, wherein each of the vibration detection sensors is a pressure sensor configured to detect pressure via elastic deformation and in contact with the vibration transmission member.

19. The hit detection device according to claim 10, wherein each of the vibration detection sensors is a pressure sensor configured to detect pressure via elastic deformation and in contact with the vibration transmission member.

20. The hit detection device according to claim 11, wherein each of the vibration detection sensors is a pressure sensor configured to detect pressure via elastic deformation and in contact with the vibration transmission member.
